(19) United States
(12) Patent Application Publication
(10) Pub. No.: US 2010/0206402 A1
(43) Pub. Date: Aug. 19, 2010

(54) VALVE DEVICE OF HIGH-PRESSURE TANK FOR VEHICLE

(76) Inventors: Chihiro Uchimura, Toyota-shi (JP); Takehisa Tsubokawa, Toyota-shi (JP); Hiroaki Suzuki, Nagoya-shi (JP); Munetoshi Kuroyanagi, Aichi-ken (JP); Toshikatsu Kubo, Okazaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/706,118

(22) Filed: Feb. 16, 2010

(30) Foreign Application Priority Data
Feb. 16, 2009 (JP) 2009-032717

(51) Int. Cl. F16K 15/00; F16K 31/44

(52) U.S. Cl. 137/511; 251/213

(57) ABSTRACT

A valve device of a high-pressure tank for a vehicle has a valve box that is attached to the high-pressure tank and that houses a gas inlet opening, a gas outlet opening, a flow path connecting the gas inlet opening, the gas outlet opening and the high-pressure tank, and a valve disposed on the flow path. The gas inlet opening, the gas outlet opening, at least a portion of the flow path, and the valve are provided on a plane that intersects perpendicularly with an axis direction of the high-pressure tank.

### INCORPORATION BY REFERENCE

The disclosure of Japanese Patent Application No. 2009-032717 filed on Feb. 16, 2009 including the specification, drawings and abstract is incorporated herein by reference in its entirety.

### BACKGROUND OF THE INVENTION

1. Field of the Invention

The invention relates to an arrangement structure of a valve device of a high-pressure tank for a vehicle.

2. Description of the Related Art

Vehicles that travel by electric power that is generated by a fuel cell that is supplied with a fuel such as a hydrogen gas or the like are generally known. Such a vehicle is equipped with a cylindrical high-pressure tank that contains the fuel that is to be used in the fuel cell, in a high pressure state.

Japanese Patent Application Publication No. 6-94196 (JP-A-6-94196) discloses a valve device that is attached to a compressed gas cylinder and that has a valve box that houses an inlet opening for gas and an outlet opening for gas, flow paths connecting the inlet opening for gas and the outlet opening for gas to the compressed gas cylinder, and valves disposed on the flow paths. The valve box of this valve device is formed so as to minimize a length thereof in the direction of diameter of the compressed gas cylinder and so as to extend in the direction of the axis of the compressed gas cylinder. Therefore, the gas inlet opening, the gas outlet opening and the valves that are disposed inside the valve box are shifted from one another in the direction of the axis of the compressed gas cylinder, and are connected by the flow paths.

If a valve device constructed as in JP-A-6-94196 is attached to a high-pressure tank that is mounted in a vehicle, the integrated device has an increased size in the direction of the axis of the high-pressure tank. However, since the high-pressure tank mounted in a vehicle is usually fixed to the vehicle body so that the tank extends in the direction of width of the vehicle, in other words, so that the axis of the high-pressure tank lies in the width direction of the vehicle, the installation space in the direction of the axis of the high-pressure tank is limited, and the installation space for the valve device does not have a good margin.

### SUMMARY OF THE INVENTION

The invention provides a valve device of a high-pressure tank for a vehicle which has a simple structure and is capable of effectively utilizing a limited installation space.

A valve device of a high-pressure tank for a vehicle in accordance with an aspect of the invention has a valve box that is attached to the high-pressure tank and that houses a gas inlet opening, a gas outlet opening, a flow path connecting the gas inlet opening, the gas outlet opening and the high-pressure tank, and a valve disposed on the flow path, wherein the gas inlet opening, the gas outlet opening, at least a portion of the flow path, and the valve are provided on a plane that intersects perpendicularly with an axis direction of the high-pressure tank.

According to the valve device of a vehicle high-pressure tank of the invention has a simple structure, and is able to effectively utilize a limited installation space.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a diagram showing a general construction of a valve device in accordance with an embodiment of the invention;

FIG. 2 is a diagram showing a construction of a valve box of the valve device of the embodiment of the invention;

FIG. 3 is a diagram showing a junction portion where a flow path is connected to a side face of a valve and a junction portion where flow paths are interconnected in a related-art technology; and

FIG. 4 is a diagram showing a junction portion where a flow path is connected to a side face of a valve and a junction portion where flow paths are interconnected in accordance with the embodiment of the invention.

### DETAILED DESCRIPTION OF EMBODIMENTS

Embodiments of the valve device of a high-pressure tank for a vehicle in accordance with the invention will be described with reference to the accompanying drawings. A motor vehicle that travels by electric power that is generated by a fuel cell, that is, a fuel cell motor vehicle, is assumed herein as an example, and a valve device of a high-pressure tank that is mounted in this fuel cell motor vehicle will be described. Incidentally, the invention is applicable not only to the fuel cell motor vehicles, but also to motor vehicles equipped with an internal combustion engine that uses a gaseous fuel, such as a natural gas or the like, as a fuel source.

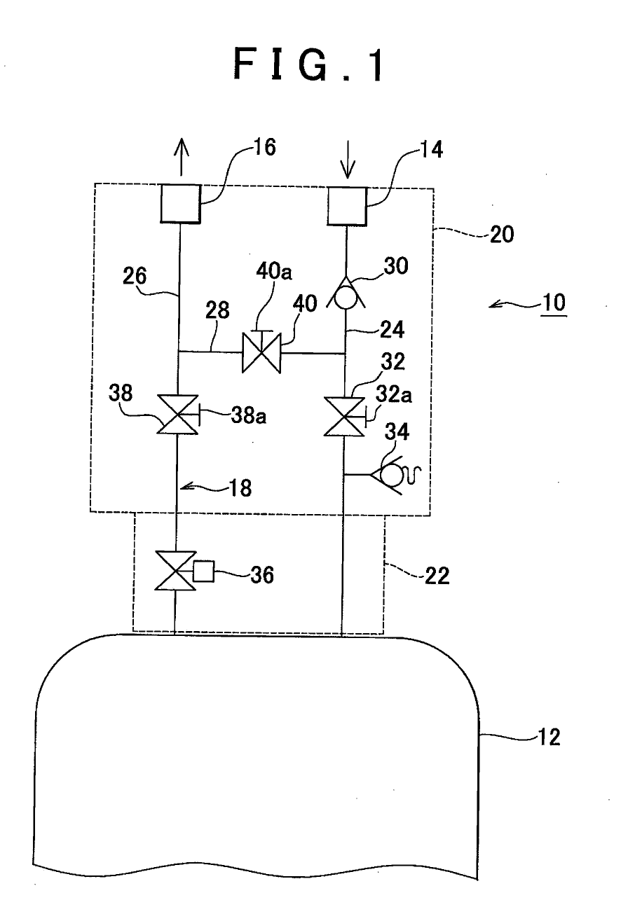

FIG. 1 is a diagram showing a general construction of a valve device in accordance with an embodiment of the invention. A valve device 10 is attached to an end portion of a high-pressure tank 12 in the direction of an axis thereof. The high-pressure tank 12 is formed in a circular tube shape, that is, a cylindrical shape, so that the pressure of the gas contained in the high-pressure tank 12 is dispersed. The pressure of the gas stored in the high-pressure tank 12 is 70 MPa. Incidentally, this pressure of the gas stored in the high-pressure tank 12 is a mere example, and the invention is not limited by this numerical value.

The valve device 10 has a valve box 20 that houses an inlet opening 14 for the gas, an outlet opening 16 for the gas, and flow paths 18 connecting the gas inlet opening 14 and the gas outlet opening 16 to the high-pressure tank 12. Besides, the valve device 10 has a trunk portion 22 that is provided between the valve box 20 and the high-pressure tank 12 and that houses the flow paths 18 that extend from the valve box 20 to the high-pressure tank 12.

The gas inlet opening 14 is an inlet opening for charging gas into the high-pressure tank 12 from an external gas source. An end portion of the gas inlet opening 14 is protruded from a surface of the valve box 20. An external gas connection opening (not shown) is connected to the protruded end portion of the gas inlet opening 14, so that the gas can be supplied from the gas source to the high-pressure tank 12.

On the other hand, the gas outlet opening 16 is an outlet opening for supplying the gas stored in the high-pressure tank 12 to the fuel cell (not shown). An end portion of the gas outlet opening 16 is protruded from the surface of the valve box 20. A gas supply passageway (not shown) that leads the gas to the fuel cell is connected to the protruded end portion of the gas outlet opening 16, so that the gas can be supplied from the high-pressure tank 12 to the fuel cell.

The flow paths 18 include a gas inlet flow path 24 that connects the gas inlet opening 14 and the high-pressure tank 12, a gas outlet flow path 26 that connects the gas outlet opening 16 and the high-pressure tank 12, and a bypass flow path 28 that connects the gas inlet flow path 24 and the gas outlet flow path 26.

A check valve 30, an inlet opening manual valve 32 and a fusible plug valve 34 are disposed on the gas inlet flow path 24 in that order from the gas inlet opening 14 toward the high-pressure tank 12. These vales 30, 32 and 34 are housed within the valve box 20. The check valve 30 is a valve that permits gas to flow in a direction from one side to the other side but prevents gas from flowing in the opposite direction. The check valve 30 in this embodiment is disposed so as to permit the gas to flow from the gas inlet opening 14 to the high-pressure tank 12 but prevents the gas from flowing from the high-pressure tank 12 to the gas inlet opening 14. The inlet opening manual valve 32 has a manipulation portion 32a that is manually manipulatable. The valve element (not shown) of the inlet opening manual valve 32 is opened and closed (turned on and off) by manipulating the manipulation portion 32a. Besides, the inlet opening manual valve 32 is also able to adjust the amount of flow of the gas. The inlet opening manual valve 32 is normally in an open state. The fusible plug valve 34 is a safety valve that is actuated depending on the ambient temperature. The fusible plug valve 34 in the embodiment is constructed so that a gasket portion (not shown) provided therein fuses to release the gas to the outside when the temperature reaches, for example, 110° C. This action of the fusible plug valve 34 prevents explosion of the high-pressure tank 12 at the time of fire or the like around the valve device 10

A main stop valve 36 and an outlet opening manual valve 38 are disposed on the gas outlet flow path 26 in that order from the high-pressure tank 12 toward the gas outlet opening 16. The main stop valve 36 is housed within the trunk portion 22, and the outlet opening manual valve 38 is housed within the valve box 20. The main stop valve 36 is an electromagnetic valve that drives an electromagnet according to an electric signal so as to open and close the valve element. The main stop valve 36 is controlled so as to be in a closed state when the vehicle is stopped, concretely, when the ignition switch is off, and so as to be in an open state when the vehicle is in operation, concretely, when the ignition switch is on. The outlet opening manual valve 38 has a manipulation portion 38a that is manually manipulatable. The valve element (not shown) of the outlet opening manual valve 38 is opened or closed (turned on or off) by manipulating the manipulation portion 38a. Besides, the outlet opening manual valve 38 is also able to adjust the amount of flow of the gas. The outlet opening manual valve 38 is normally in the open state.

A bypass manual valve 40 is disposed on the bypass flow path 28. The bypass manual valve 40 is housed within the valve box 20. The bypass manual valve 40 has a manipulation portion 40a that is manually manipulatable. The valve element (not shown) of the bypass manual valve 40 is opened and closed (turned on and off) by manipulating the manipulation portion 40a. The bypass manual valve 40 is normally in the closed state. However, in the case where the main stop valve 36 is broken in the closed state, the bypass manual valve 40 is opened to allow the gas stored in the high-pressure tank 12 to flow from the gas inlet flow path 24 to the gas outlet flow path 26 through the bypass flow path 28, so that the gas is released to the outside from the gas outlet opening 16.

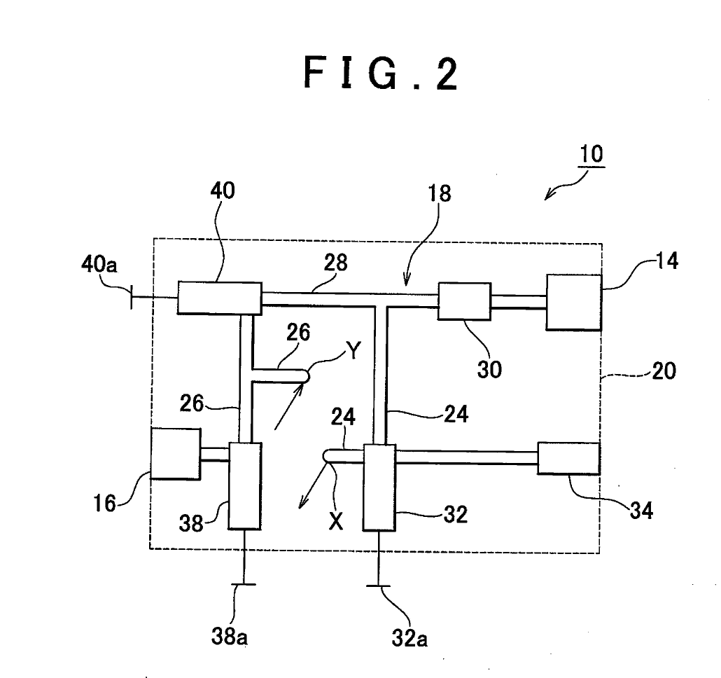

The valve device 10 of this invention is characterized in that the gas inlet opening 14, the gas outlet opening 16, the flow paths 18 and the valves housed within the valve box 20 are provided on the same plane that intersects perpendicularly with the axis of the high-pressure tank 12. The valves herein refers to the check valve 30, the inlet opening manual valve 32, the fusible plug valve 34, the outlet opening manual valve 38 and the bypass manual valve 40. The valve device 10 will be concretely described with reference to FIG. 2 below.

FIG. 2 is a diagram showing a construction of the valve box 20 of the valve device 10. This diagram shows a construction on a plane within the valve box 20 which interests perpendicularly with the axis of the high-pressure tank 12. Therefore, as for this diagram, it is assumed that the axis of the high-pressure tank 12 is assumed to extend in a direction perpendicular to the plane of the sheet of the diagram, and that the trunk portion 22 and the high-pressure tank 12 are positioned at the other side of the plane of the diagram, that is, behind the plane.

As shown in FIG. 2, the gas inlet opening 14 and the gas outlet opening 16 are disposed on the same plane. Besides, the valves, that is, the check valve 30, the inlet opening manual Valve 32, the fusible plug valve 34, the outlet opening manual valve 38 and the bypass manual valve 40, are also disposed on the same plane. It is to be noted herein that the “valves are disposed on the same plane” means that the valves are disposed so that axes of the valves, for example, the axes of the valve elements within the valves or the axes of the valve chambers, are contained in the plane.

The gas inlet flow path 24 is formed also on the same plane so as to connect the gas inlet opening 14, the check valve 30, the inlet opening manual valve 32 and the fusible plug valve. 34. Besides, the gas outlet flow path 26 is formed on the same plane so as to connect the gas outlet opening 16 and the outlet opening manual valve 38. The bypass flow path 28 is also formed on the same plane so as to connect the gas inlet flow path 24 and the gas outlet flow path 26 via the bypass manual valve 40. Incidentally, the gas inlet flow path 24 extends toward the other side of the plane of the diagram from the point denoted by symbol X, and extends through the trunk portion 22 and connects to the high-pressure tank 12. Besides, the gas outlet flow path 26 also extends toward the other side of the plane of the diagram from the point denoted by symbol Y, and extends through the trunk portion 22 and connects to the high-pressure tank 12.

Thus, since various component elements of the valve device 10, that is, the gas inlet opening 14, the gas outlet opening 16, the valves and the flow paths 18 are provided on the same plane in the valve box 20, the valve device 10 can be reduced in size in the axis direction of the high-pressure tank 12. Since the valve device 10 is reduced in size in the axis direction thereof, it becomes possible to effectively utilize a limited installation space in a vehicle, even in the case where the high-pressure tank 12 is mounted in a vehicle so that the high-pressure tank 12 extends in the width direction of the vehicle, that is, the axis of the high-pressure tank 12 lies in the vehicle width direction. Besides, since the valve device 10 is reduced in size in the axis direction thereof, a margin is provided in the installation space, so that the high-pressure tank 12 can be increased in size.

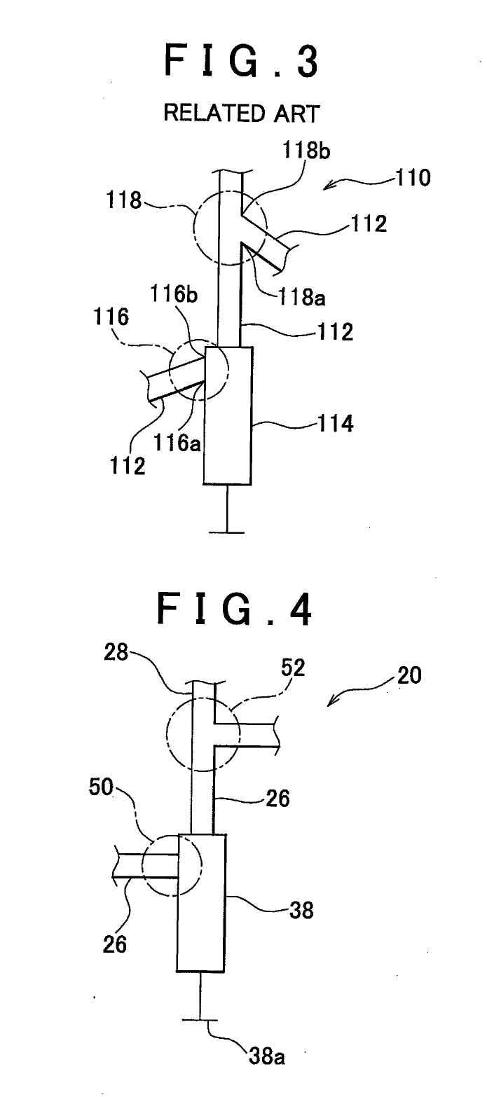

In the related-art valve box, too, size reduction is sought by considering the arrangement of the component elements. However, if size reduction is sought simply by reducing the arrangement intervals between the component elements, the durability of the valve device deteriorates. This will be concretely described with reference to FIG. 3. FIG. 3 is a diagram of a valve box 110 in accordance with the related art, showing a junction portion 116 in which a flow path 112 and a valve 114 are connected, and a junction portion 118 in which flow paths 112 are connected. The junction portion 116 is constructed so that the flow path 112 intersects obliquely with the axis of the valve 114. The junction portion 118 is constructed so that the flow paths 112 intersect obliquely with each other. If high-pressure gas flows in the junction portions 116 and 118 that are constructed in the foregoing manner, larger tensile stress concentrates in acute-angled portions 116a and 118a than in obtuse-angle portions 116b and 118b, and this tensile stress reduces the fatigue life of the junction portions 116 and 118.

In the valve device 10 of the invention, therefore, a flow path 18 is connected to a side surface of a valve so that the flow path 18 is orthogonal to the axis of the valve, and flow paths 18 are interconnected so as to be orthogonal to each other.

An example of a concrete construction as described above is shown in

FIG. 4. FIG. 4 is an enlarged view of the outlet opening manual valve 38 and its surroundings shown in FIG. 2, and shows a valve side face junction portion 50 where the gas outlet flow path 26 is connected to a side face of the outlet opening manual valve 38, and a flow path junction portion 52 where the gas outlet flow path 26 is connected to the bypass flow path 28. The valve side face junction portion 50 is constructed so that the gas outlet flow path 26 is orthogonal to the axis of the outlet opening manual valve 38, and the flow path junction portion 52 is constructed so that gas outlet flow path 26 and the bypass flow path 28 are orthogonal to each other. If high-pressure gas flows in the valve side face junction portion 50 and the flow path junction portion 52 that are constructed as described above, tensile stress does not locally concentrate, but uniformly occurs, so that the service life of the valve device can be increased. Incidentally, although this embodiment has been described in conjunction with the construction of the outlet opening manual valve 38 and its surroundings, other junction portions in the valve box 20 can also be constructed substantially in the same manner.

Besides, the valve device 10 of this embodiment is characterized in that the manipulation portion 32a of the inlet opening manual valve 32 and the manipulation portion 38a of the outlet opening manual valve 38 are disposed so as to face in the same direction. As shown in FIG. 2, the two manipulation portions 32a and 38a are disposed facing toward a lower side in the drawing. Due to this construction, maintenance of the valve device 10 mounted in a vehicle can be carried out in a state that a service person needs only to see one side surface of the valve device 10 in order to manipulate the manipulation portions 32a and 38a. Since the bypass manual valve 40 in the embodiment is not manipulated when the valve device 10 is mounted in a vehicle, the manipulation portion 40a of the bypass manual valve 40 is not disposed so as to face in the same direction as the manipulation portions 32a and 38a of the other manual valves 32 and 38. However, the embodiment is not limited to this construction, that is, the manipulation portion 40a of the bypass manual valve 40 may be disposed so as to face in the same direction as the manipulation portions 32a and 38a of the other manual valves 32 and 38.

Although the embodiment has been described in conjunction with the construction in which the valves housed within the valve box 20 are the check valve 30, the inlet opening manual valve 32, the fusible plug valve 34, the outlet opening manual valve 38 and the bypass manual valve 40, the embodiment is not limited to this construction, but other valves may also be housed in the valve box 20. Besides, although the embodiment has been described in conjunction with the case where the main stop valve 36 is housed within the trunk portion 22, the main stop valve 36 may instead be housed within the valve box 20.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. A valve device of a high-pressure tank for a vehicle, comprising:
a valve box that is attached to the high-pressure tank and that houses a gas inlet opening, a gas outlet opening, a flow path connecting the gas inlet opening, the gas outlet opening and the high-pressure tank, and a valve disposed on the flow path, wherein
the gas inlet opening, the gas outlet opening, at least a portion of the flow path, and the valve are provided on a plane that intersects perpendicularly with an axis direction of the high-pressure tank.

2. The valve device according to claim 1, further comprising a valve side face junction portion in which the flow path is connected to a side face of the valve,
wherein the valve side face junction portion is constructed so that the flow path is orthogonal to an axis of the valve.

3. The valve device according to claim 1, further comprising a flow path junction portion in which a flow path and another flow path are connected to each other,
wherein the flow path junction portion is constructed so that the flow path and the another flow path are orthogonal to each other.

4. The valve device according to claim 1, wherein:
the valve includes an inlet opening manual valve that is disposed on the flow path connecting the gas inlet opening and the high-pressure tank, and that has a manipulation portion that is manually manipulatable, and an outlet opening manual valve that is disposed on a flow path connecting the gas outlet opening and the high-pressure tank, and that has a manipulation portion that is manually manipulatable; and
the inlet opening manual valve and the outlet opening manual valve are disposed so that the manipulation portion of the inlet opening manual valve and the manipulation portion of the outlet opening manual valve face in the same direction.

5. The valve device according to claim 1, wherein:
the valve includes a plurality of valves provided on flow paths; and
the gas inlet opening, the gas outlet opening, at least a portion of the flow path, and at least one of the plurality of valves are provided on a plane that intersects perpendicularly with an axis direction of the high-pressure tank.
